(19) United States
(12) Patent Application Publication
(10) Pub. No.: US 2004/0144195 A1
(43) Pub. Date: Jul. 29, 2004

(54) Brake control device on steering wheel

(76) Inventors: Yvon Rancourt, Quebec (CA); Alain Constans, Quebec (CA); M?apos;hamed El-Haouari, Quebec (CA)

Correspondence Address: BIRCH STEWART KOLASCH & BIRCH, PO BOX 747, FALLS CHURCH, VA, 22040-0747, US

(21) Appl. No.: 10/469,512

(22) PCT Filed: Mar. 4, 2002
(86) PCT No.: PCT/CA02/00269

(30) Foreign Application Priority Data
Mar. 2, 2001 (CA) 2,339,740

(51) Int. Cl. B62D 1/04

(52) U.S. Cl. 74/552

(57) ABSTRACT

Disclosed is an improved vehicle braking activation system (10), which provides faster response time by using a hand operated steering wheel mounted braking control system. A centralized end ball (90) underneath a pressure plate (12) within the steering wheel (52), depresses an underlying deformable sensing beam (46) when force is applied by the driver on the pressure plate (12). The signal output of a strain gauge sensor (98) on the sensing beam (46), could then provide the input or a braking controller to electronically control braking proportionally.

### BACKGROUND OF THE INVENTION

1. Field of the Invention

This invention relates to an improved car braking system. More specifically, it is concerned with a steering wheel mounted braking control device.

2. Description of the Prior Art

Optimized braking in performance sports cars is a vital part of both road safety and racetrack success. Response time of the driver can significantly affect the braking distance required to efficiently slow a fast moving vehicle. Fractions of seconds could potentially mean the difference between stopping in time and having an accident. The traditional braking method used in most cars today is the foot activated pedal brake. While this is a reliable method, and is effective because of the strong force that can be exerted on the mechanical brake pedal by the driver, moving a foot over to the brake pedal and pushing down on the mechanical brake linkage requires significant time in the world of auto racing. The fractions of a second lost are costly in a sport where everything is scrutinized in order to save valuable time. With the present steering wheel-mounted brake activation system, less time would be lost between the driver's initial reaction and the application of the brakes.

It is well known that the eye-hand coordination is faster than the eye-foot coordination. A brake control operated by the hand, on the steering hand would have some distinct advantages in respect of response time as opposed to a foot-pedal control.

Existing prior art in this field is generally concerned with hand operated vehicle control devices for handicapped users. Most comprise mechanical devices of varying complexities for operating the accelerator and brake pedals remotely by hand from the steeling wheel or column.

U.S. Pat. No. 5,666,857 issued Sep. 16, 1997 to Sebazco discloses a motor vehicle steering and braking control system. A mechanism fixed between the steering wheel and the brake pedal allows the brake pedal to be depressed when the operator exerts a downward force on the steering wheel.

U.S. Pat. No. 4,078,628 issued Mar. 14, 1978 to Reichenberger discloses an hand operated automotive control system which is capable of operating both the throttle and braking systems through an electro-hydraulic servo system. The device includes a control wheel, concentrically mounted within the conventional steering wheel, which is connected to a position sensor detecting the relative position of the plane of the second control wheel relative to the steering wheel. The sensor output signal is amplified and sent to a torque motor which controls the position of a linear actuator. Movement of the linear actuator in one direction applies pressure to the brake system, and in the other increases the throttle setting. Therefore, movement of the control wheel away from the driver activates the vehicles brakes, and movement towards the driver activates the throttle.

U.S. Pat. No. 5,603,674 issued Feb. 18, 1997 to Rivas et al. and Canadian Patent 2,130,334 issued Aug. 3, 1999 to Rivas both disclose a set of motor vehicle controls for assisting drivers handicapped in the lower limbs, comprising controls for the accelerator, brake and clutch, and a plurality of motors, each controlling a pedal assembly. The control for the brake and accelerator are located on the steering wheel, comprising a freely rotating internal hoop bearing two concentric annular sensors for the brake and accelerator. A second set of controls, independent of the steering wheel, is used for controlling the clutch and the brake.

U.S. Pat. No. 4,077,487 issued Mar. 7, 1978 to Misinchuk and corresponding Canadian Patent 1,049,590 issued Feb. 27, 1979 to the same inventor, disclose an auxiliary braking system for a vehicle comprised of a steering wheel mounted control switch which is electrically connected to a linear motor linked to the control rod of the braking vehicle braking system. This permits the driver to apply and free the brakes of the vehicle by sliding the switch on the steering wheel with a thumb or finger of his hand.

U.S. Pat. No. 5,025,905 issued Jun. 25, 1991 to Lenz and Canadian Patent 1,320,413 issued Jul. 27, 1993 to the same inventor, disclose a hand control device for operating both the accelerator and brake pedals of a motor vehicle. This invention comprises a lever mechanism which pushes down on an accelerator pedal control member when rotated in one direction, and pushes down on a brake pedal control member when rotated the other direction.

U.S. Pat. No. 5,129,492 issued Jul. 14, 1992 to Lenz discloses a device similar to U.S. Pat. No. 5,025,905 having additionally a flexible support loop passing around the vehicle steering column for receiving and supporting one of the control members.

Therefore, while a significant amount of prior art exists for hand activated automotive brake controls, most employ a mechanical connection directly attached to the brake pedal. This type of system is often complex and takes up considerable space. The actuation of this type of mechanical system often requires levers to be pulled or pushed, and therefore a hand must be removed from the steering wheel in order to actuate the braking system. This both slows braking reaction time, and means that steering is negatively affected when braking is required. This can be dangerous when situations arise which require the drive to simultaneously slow down and avoid an obstacle or other vehicle. The few prior art braking systems which utilize electrical signals, nevertheless require hydro-mechanical servos or motors which translate a displacement of a steering wheel mounted switch into displacement of the brakes. These types of systems often require significant skill to control the wheel mounted switches, as they must be accurately displaced by an amount which corresponds to the level of braking required. This movement of the wheel mounted switch also takes more time which reduces the overall time between the driver reaction and the brake application.

### SUMMARY OF THE INVENTION

It is an object of the present invention to provide an improved vehicle braking activation system.

It is a further object of the present invention to provide a hand operated, steering wheel-mounted, braking control system providing faster response time, without negatively affecting vehicle steering control.

Therefore, in accordance with the present invention there is provided a steering wheel mounted vehicle braking actuation system adapted for use with a braking controller capable of accepting electrical input signals and controlling brake activation accordingly, the vehicle braking actuation system comprising: an elastically deflectable member mounted within the steering wheel of the vehicle, and adapted to be deflected by an actuating force applied by a hand of a user; and an electrical strain gauge sensor fixed to the elastically deflectable member and providing an electrical output signal in response to the actuating force applied; whereby the electrical output signal provides a direct input to the braking controller.

There is also provided, in accordance with the present invention, a method of brake actuation for a vehicle comprising the steps of: exerting an actuating force on a steering wheel mounted, hand actuated pressure plate; transmitting the actuating force from the pressure plate to an elastically deflectable sensing member; and detecting a deflection of the elastically deflectable sensing member with a strain gauge sensor fixed thereto; providing an electrical output signal from the strain gauge sensor in proportional response to the deflection of the elastically deflectable sensing member; transmitting the electrical output signal directly to a vehicle braking activation element.

These objects of the present invention will become fully apparent by referring to the following detailed description of the preferred embodiments, claims, and the accompanying drawings.

### BRIEF DESCRIPTION OF THE DRAWINGS

FIG. 1 is an exploded perspective view of the brake control assembly;

FIG. 2 is a rear perspective view of the brake control assembly;

FIG. 3a is a horizontal elevational view of the brake control device without the steering wheel;

FIG. 3b is a schematic view showing an exaggerated deflection of the sensing beam;

FIG. 4 is a side perspective view of the brake control assembly;

FIG. 5a is a perspective view of the steering column mating flange;

FIG. 5b is a side elevational view of the detail shown in FIG. 5a;

FIG. 6a is a perspective view of the steering column adapter pivot;

FIG. 6b is a partial axial cross-sectional view of the detail shown in FIG. 6a; and

FIG. 7 is a perspective view of the underside of the braking

interface pressure plate.

### DESCRIPTION OF THE PREFERRED EMBODIMENT

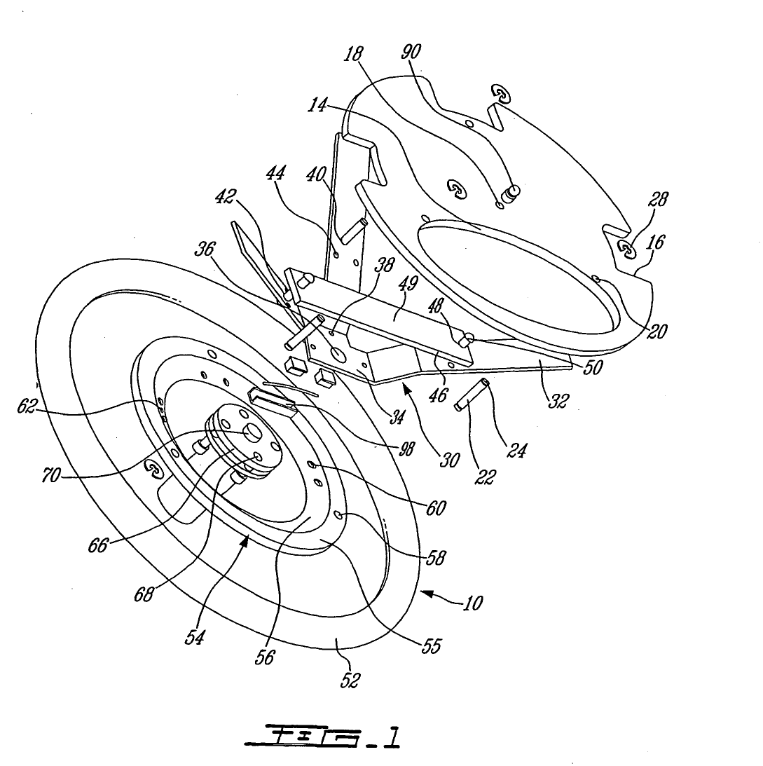

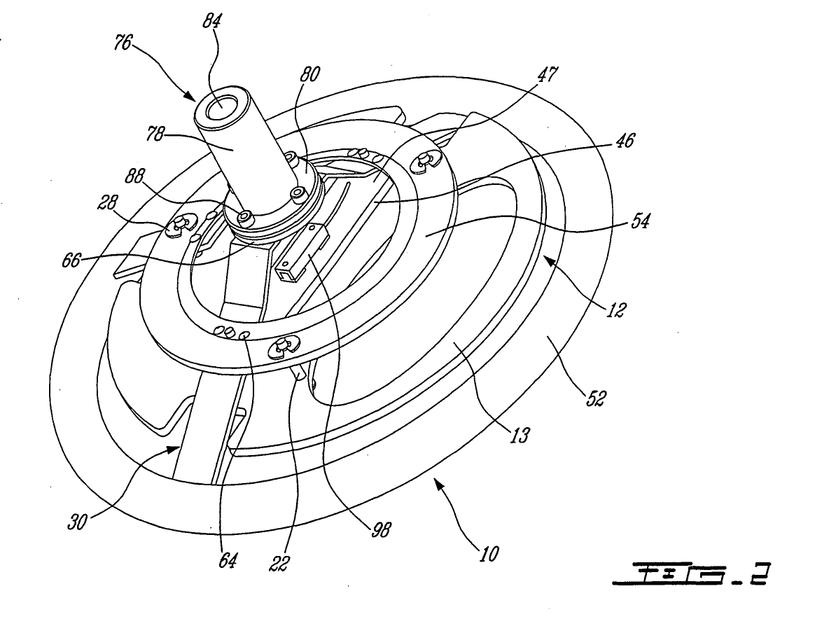

Referring now to FIGS. 1 and 2 of the brake control assembly device 10, a generally circular braking interface pressure plate 12 is shown mounted on a steering wheel. The plate 12 defines a lower oval cut-out region 14, three radially located rectangular cut-outs 16 for spoke clearance spaced at 90° from each other, a circular centre hole 18 and three dowel pin holes 20 equally spaced 120° apart. The braking interface pressure plate 12 can equally be modified to be of various shapes, in order to accommodate the most effective and ergonomic design. A central end ball 90 fits into the centre hole 18 and protrudes from the lower surface 13 of the pressure plate 12. Dowel pins 22 retain the pressure plate 12, and permit slideable translation when the driver's fingers or hands depress the plate. The annular circumferential slots 24 on either end of the dowel pins 22 for reception of the C-clip fasteners 28, retain the dowel pins 22 in place, ensure contact between the end ball 90 and the sensing beam 46, and prevent the disassembly of the entire device. The dowel pins 22 descend down through the holes 58 in the support ring 54 which is fixed to the spokes 32 of the spoke element 30.

The spoke element 30 is comprised of the three spokes 32 spaced at 90° from each other. The T-shaped base plate 34 has a large circular centre hole 36 and three smaller circular threaded holes 38. All three spokes each have two support ring fastener holes 44. The two laterally opposing spokes 32 also include two sensing beam fastener holes 44. The remaining upwardly extending spoke includes a single dowel pin hole 40. The central end ball 90 protruding from the lower surface 13 of the pressure plate 12 rests on the top surface 49 of the rectangular sensing beam 46, which itself is fixed by two beam fastener pins 50 onto the laterally opposing spokes 32.

Referring also to FIG. 2, the steering wheel rim 52 is fixed to the ends of the spokes 32. The pressure plate support ring 54 is fixed to the underside of the spokes 32 by six spoke fastener pins 64 through the spoke fastener holes 60. The support ring 54 has a chamfered inside surface 56 for mating with the undersides of the spokes 32. This permits the flat top surface 55 of the support ring 54 to remain parallel to the pressure plate 12. Therefore ensuring that the dowel pin holes 58 allow the pins 22 to be perpendicular to both the top surface 55 of the support ring 54 and the under surface 13 of the pressure plate 12. This ensures that the pressure plate 12 can slide freely on the dowel pins 22, and that the force applied to the top of the pressure plate 12 will cause the end ball 90 to deflect the rectangular sensing beam 46 in an amount proportional to the force applied to the pressure plate 12 by the driver.

A strain gauge sensor 98 is fixed to the under surface 47 of the rectangular sensing beam 46. This sensor measures the strain in the sensing beam 46 created by the centralized force applied to it by the end ball 90 mounted to the pressure plate 12. The entire assembled spoke element 30 to which the steering wheel rim 52, pressure plate support ring 54 and sensing beam 46 are also attached, is fixed to the vehicle steering shaft by a steering column mating flange 66 and a steering column adapter pivot 76.

The steering column mating flange 66 comprises four radial equally spaced cap screw holes 68, a top circular boss 70, a bottom circular boss 72 of larger diameter, and circumferential edge chamfers 74. The T-shaped base plate 34 of the spoke element 30 meets with the steering column mating flange 66. They are radially aligned by the top circular boss 70 of the column mating flange 66 fitting into the large circular centre hole 36 in the T-shaped base plate 34 of the spoke elements 30. The larger diameter bottom circular boss 72 of the steering column mating flange 66 protrudes into the centre axial hole 86 in the top radial flange 80 of the steering column adapter pivot 76, thereby radially aligning the entire brake control assembly 10.

The four cap screw holes 82 in the top radial flange 80 of the adapter pivot 76, can then be aligned with the four cap screw holes 68 of the mating flange 66, and the three threaded cap screw holes 38 of the T-shaped base plate 34 of the spoke element 30. The cap screws 88 then provide the axial fixation of all the elements of the brake control assembly 10. The smaller diameter centre axial through hole S4 of the cylindrical body 78 in the steering column adapter pivot 76, is intended for slideable mating with and fixation onto the end of the steering column shaft of the vehicle.

The entire invention therefore is a brake activation device, for an electronic braking system. When the driver applies force on the pressure plate 12, the transferred force concentrated at the centre through the end ball 90 and onto the deformable sensing beam 46, provides the mechanical input which the strain gauge sensor 98.

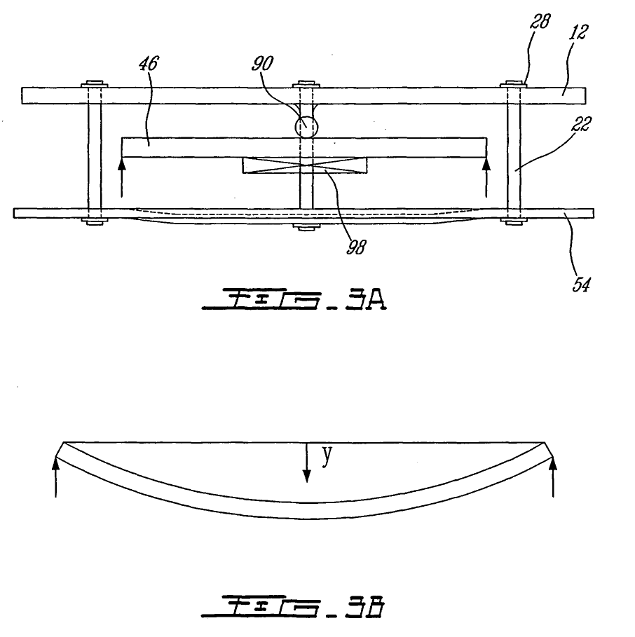

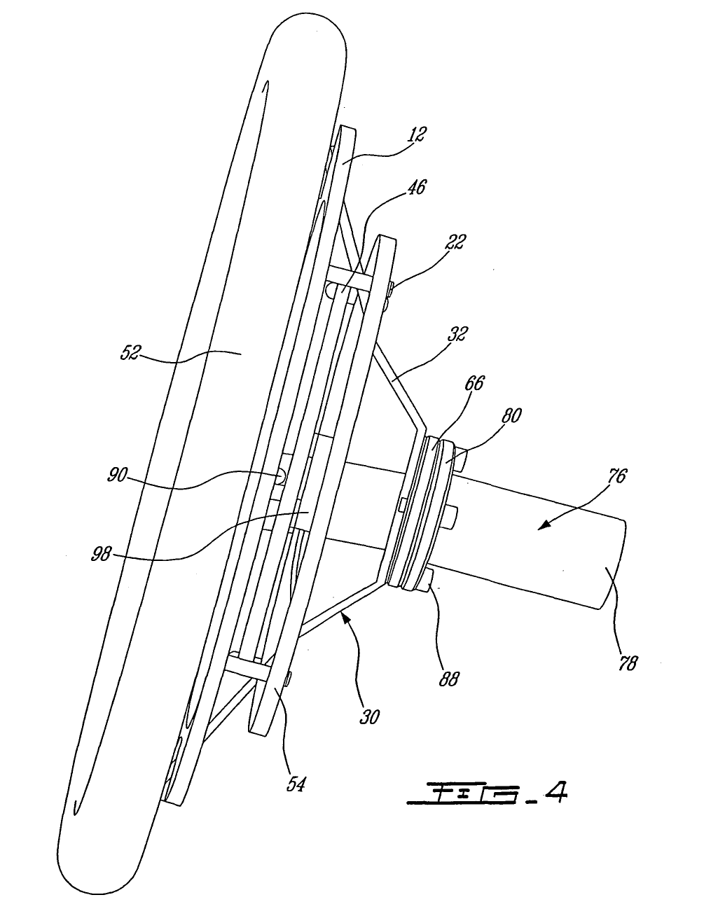

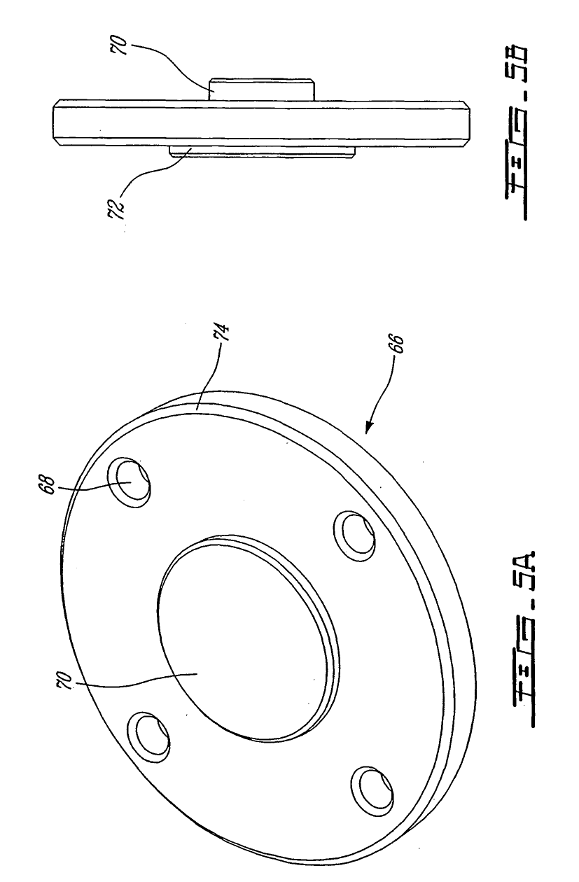

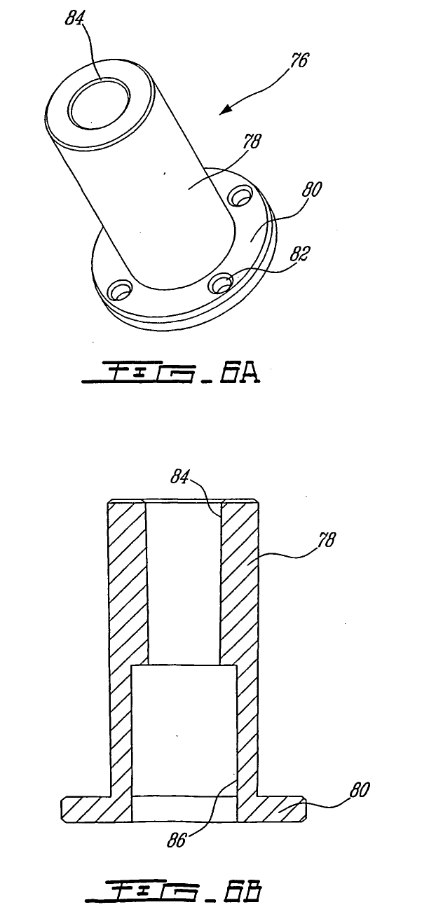

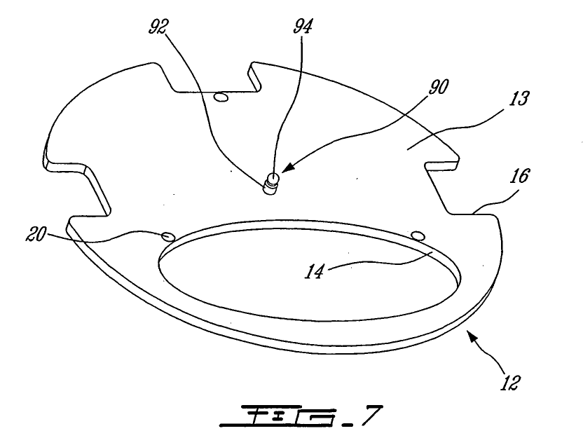

Referring to FIG. 3, the amount of deformation Y of the sensing beam 46 is detected by the attached strain gauge sensor 98, which transmits a corresponding electrical signal equivalent to the degree of strain in the sensing beam 46, to a separate braking controller which would manage the input signals and proportionally control the braking according. The output of the stain gauge sensor 98 could also be amplified or reduced according to need and braking calibration required. Therefore, the force applied to the pressure plate 12 by the driver and picked up by the strain gauge sensor 98, would be electronically sent directly to the brakes. This eliminates the slower traditional mechanical braking system movements and slower physical movements required by the driver for applying a foot brake pedal, and therefore reduces reaction time and permits faster brake application.

Although the preferred embodiment of the present invention has been described in the foregoing specification in detail, it is to be understood that minor modifications may be made to the invention without departing from the scope and purview of this invention as defined by the appended claims.

1. A braking control system for a vehicle comprising:
a hand controlled braking interface means;
a deformable sensing beam member;
a localized force transmission means between said hand controlled braking interface means and said deformable sensing beam member; and
an electrical strain gauge sensor.

2. The invention as defined in claim 1, wherein said hand controlled braking interface is a steering wheel mounted pressure plate.

3. The invention as defined in claim 2, wherein said force transmission means is an end ball mounted under said steering wheel mounted pressure plate.

4. The invention as define in claim 1, wherein said electrical strain gauge sensor is mounted on said deformable sensing beam member.

5. A steering wheel mounted vehicle braking actuation system adapted for use with a braking controller capable of accepting electrical input signals and controlling brake activation accordingly, the vehicle braking actuation system comprising:
an elastically deflectable member mounted within the steering wheel of the vehicle, and adapted to be deflected by an actuating force applied by a hand of a user; and
an electrical strain gauge sensor fixed to the elastically deflectable member and providing an electrical output signal in response to the actuating force applied;
whereby the electrical output signal provides a direct input to the braking controller.

6. The braking actuation system as defined in claim 5, wherein the actuating force is applied to a hand actuated pressure plate, contiguous with the elastically deflectable member.

7. The braking actuation system as defined in claim 5, wherein the electrical output signal is substantially proportional to the actuating force applied.

8. The braking actuation system as defined in claim 7, wherein the discrete braking controller is adapted to apply a vehicle braking force proportional to the electrical output signal.

9. The braking actuation system as defined in claim 6, wherein the hand actuated pressure plate can be actuated without releasing the steering wheel.

10. The braking actuation system as defined in claim 6, wherein the hand actuated pressure plate displaces an amount substantially corresponding to an amount of deflection of said elastically deflectable member.

11. The braking actuation system as defined in claim 5, wherein the electrical output signal produced by the strain gauge sensor is substantially proportional to an amount of defection of the elastically deflectable member.

12. The braking actuation system as defined in claim 6, wherein a localized force transmission member fixed to the pressure plate is adapted to transmit force between the pressure plate and the elastically deflectable member.

13. The braking actuation system as defined in claim 12, wherein the elastically deflectable member is a beam fixed at its ends.

14. The braking actuation system as defined in claim 13, wherein the localized force transmission member acts substantially at the middle of the beam.

15. A method of brake actuation for a vehicle comprising the steps of:
exerting an actuating force on a steering wheel mounted, hand actuated pressure plate;
transmitting the actuating force from the pressure plate to an elastically deflectable sensing member; and
detecting a deflection of the elastically deflectable sensing member with a strain gauge sensor fixed thereto;
providing an electrical output signal from the strain gauge sensor in proportional response to the deflection of the elastically deflectable sensing member;
transmitting the electrical output signal directly to a vehicle braking activation element.
